(19) United States
(12) Patent Application Publication
(10) Pub. No.: US 2011/0153334 A1
(43) Pub. Date: Jun. 23, 2011

(54) METHOD FOR EXTRACTING PROBABILITY MODEL VALUE FROM PROBABILITY MODEL TABLE AND METHOD AND APPARATUS FOR DECODING SYMBOL VALUE BY USING THE SAME

(75) Inventors: Min Seok CHOI, Daejeon (KR); Seong Mo Park, Daejeon (KR); Nak Woong Eum, Daejeon (KR)

(73) Assignee: ELECTRONICS AND TELECOMMUNICATIONS RESEARCH INSTITUTE, Daejeon (KR)

(21) Appl. No.: 12/969,616

(22) Filed: Dec. 16, 2010

(30) Foreign Application Priority Data
Dec. 18, 2009 (KR) 10-2009-0127515
Nov. 22, 2010 (KR) 10-2010-0116262

(51) Int. Cl. G10L 19/00

(52) U.S. Cl. 704/500; 704/E19.001

(57) ABSTRACT

A method for extracting a probability model value from a probability model table and a method and apparatus for decoding a symbol value using the same are provided. The method for extracting a probability model value from a probability model table includes: segmenting and reducing a probability model table including a plurality of probability model values; disposing indexes on the basis of the segmented and reduced probability model table; and searching the probability model table for a probability model value by using the disposed indexes.

### CROSS-REFERENCE TO RELATED APPLICATIONS

This application claims the priority of Korean Patent Application No. 10-2009-0127515 filed on Dec. 18, 2009 and Korean Patent Application No. 10-2010-0116262 filed on Nov. 22, 2010, in the Korean Intellectual Property Office, the disclosure of which is incorporated herein by reference.

### BACKGROUND OF THE INVENTION

1. Field of the Invention

The present invention relates to a method for extracting a probability model value from a probability model table and a method and apparatus for decoding a symbol value using the same, and more particularly, to a method for extracting a probability model value from a probability model table having a reduced amount of calculation and a method and apparatus for decoding a symbol value using the same.

2. Description of the Related Art

Recently, as a DMB (Digital Multimedia Broadcasting) reception terminal has been rapidly spreading and has become generalized, users can enjoy a high quality multimedia service through a personal mobile device such as a vehicle terminal, a mobile phone, a PDA, or the like, in a mobile reception environment.

An ISO/IEC 14496-3 BSAC (Bit Sliced Arithmetic Coding) standard has been adopted as an audio coding scheme in a Korean standard for DMB service, in particular, terrestrial DMB service. The BSAC is one of a natural audio coding methods of MPEG-4, and its basic signal processing techniques for compression are the same as those of MPEG-4 AAC (Advanced Audio Coding), a typical high sound quality audio coding method; however, the BSAC is different from the MPEG-4 AAC in that it uses arithmetic coding, instead of Huffman coding, as a lossless coding method.

An arithmetic decoding process in a BSAC audio decoding process is used to restore an MDCT (Modified Discrete Cosine Transform) coefficient from a coded MPEG-4 BSAC bit stream, which is sequentially performed from a lower layer to a higher layer by scalability layer.

The arithmetic decoding process, however, requires a great amount of calculation in the process of finding a probability model value of each bit with respect to each symbol, having difficulty in being implemented in a universal DSP (Digital Signal Processor), or the like.

Thus, a method of implementing the process of finding a probability model value in the arithmetic decoding process by using dedicated hardware, a method of reducing a search range by segmenting a probability model table, or the like, has been proposed.

In this case, however, there is a burden of additionally developing dedicated accelerating hardware for the arithmetic decoding process, and a major calculation in the arithmetic decoding process arises from the condition of searching an index with respect to the probability model table and a branching process, so the method for fragmenting the probability model table cannot achieve the effect of greatly reducing the amount of required calculation.

### SUMMARY OF THE INVENTION

An aspect of the present invention provides a method for extracting a probability model value from a probability model table.

Another aspect of the present invention provides a method for decoding a symbol value using a method for extracting a probability model value from a probability model table.

Another aspect of the present invention provides an apparatus for decoding a symbol value using a method for extracting a probability model value from a probability model table.

According to an aspect of the present invention, there is provided a method for extracting a probability model value from a probability model table, including: segmenting and reducing a probability model table including a plurality of probability model values; disposing indexes on the basis of the segmented and reduced probability model table; and searching the probability model table for a probability model value by using the disposed indexes.

The disposing of the indexes on the basis of the segmented and reduced probability model table may remove an unnecessary index searching process.

According to an aspect of the present invention, there is provided a method for decoding a symbol value using a method for extracting a probability model value from a probability model table, including: receiving a symbol value to be decoded; extracting a probability model value from a probability model table; and decoding the received symbol value by using the extracted probability model value.

The extracting of the probability model value from the probability model table may include: segmenting and reducing the probability model table including a plurality of probability model values; disposing indexes on the basis of the segmented and reduced probability model table; and searching the probability model table for a probability model value by using the disposed indexes.

The disposing of the indexes on the basis of the segmented and reduced probability model table may remove an unnecessary index searching process.

The symbol value decoding method may be used for BSAC (Bit Sliced Arithmetic Coding) decoding, an audio coding standard of terrestrial DMB (Digital Multimedia Broadcasting).

According to an aspect of the present invention, there is provided an apparatus for decoding a symbol value by using a method for extracting a probability model value from a probability model table, including: a memory storing a probability model table including a plurality of probability model values; and a processor receiving a symbol value to be decoded, extracting a probability model value from the probability model table stored in the memory, and decoding the received symbol value.

When the processor extracts the probability model value from the probability model table, it may segment and reduce the probability model table including a plurality of probability model values, dispose of indexes on the basis of the segmented and reduced probability model table, and search the probability model table for a probability model value.

The symbol value decoding apparatus may be used for BSAC (Bit Sliced Arithmetic Coding) decoding, an audio coding standard of terrestrial DMB (Digital Multimedia Broadcasting).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flow chart illustrating the process of a method for extracting a probability model value from a probability model table according to an exemplary embodiment of the present invention;

FIGS. 2 and 3 are views illustrating a method for extracting a probability model value from a probability model table according to the related art;

FIGS. 4 and 5 are views illustrating a method for extracting a probability model value from a probability model table according to an exemplary embodiment of the present invention;

FIG. 6 is a flow chart illustrating the process of a method for decoding a symbol value by using a method for extracting a probability model value from a probability model table according to an exemplary embodiment of the present invention; and

FIG. 7 is a schematic block diagram of an apparatus for decoding a symbol value by using a method for extracting a probability model value from a probability model table according to an exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

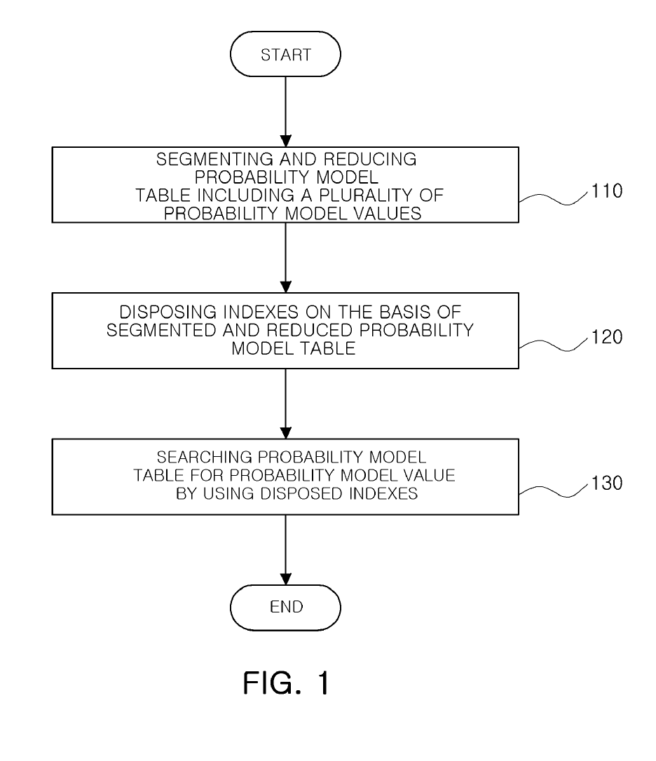

FIG. 1 is a flow chart illustrating the process of a method for extracting a probability model value from a probability model table according to an exemplary embodiment of the present invention.

With reference to FIG. 1, a method for extracting a probability model value from a probability model table according to an exemplary embodiment of the present invention includes: a step (110) of segmenting and reducing a probability model table including a plurality of probability model values; a step (120) of disposing indexes on the basis of the segmented and reduced probability model table; and a step (130) of searching the probability model table for a probability model value by using the disposed indexes.

First, in the step (110) of segmenting and reducing the probability model table including the plurality of probability model values, the respective probability model values of the probability model table may be segmented and a reducible item may be reduced.

Next, in the step (120) of disposing the indexes on the basis of the segmented and reduced probability model table, an unnecessary index may be removed from the indexes to allow the segmented and reduced probability model table to be well shown.

Also, in the step (120) of disposing the indexes on the basis of the segmented and reduced probability model table, an unnecessary index searching process may be eliminated.

In the step (130) of searching the probability model table for a probability model value by using the disposed indexes, the probability model table may be searched for a probability model value and the searched probability model value may be extracted.

Namely, the probability model value may be searched and extracted so as to be used for a decoding operation.

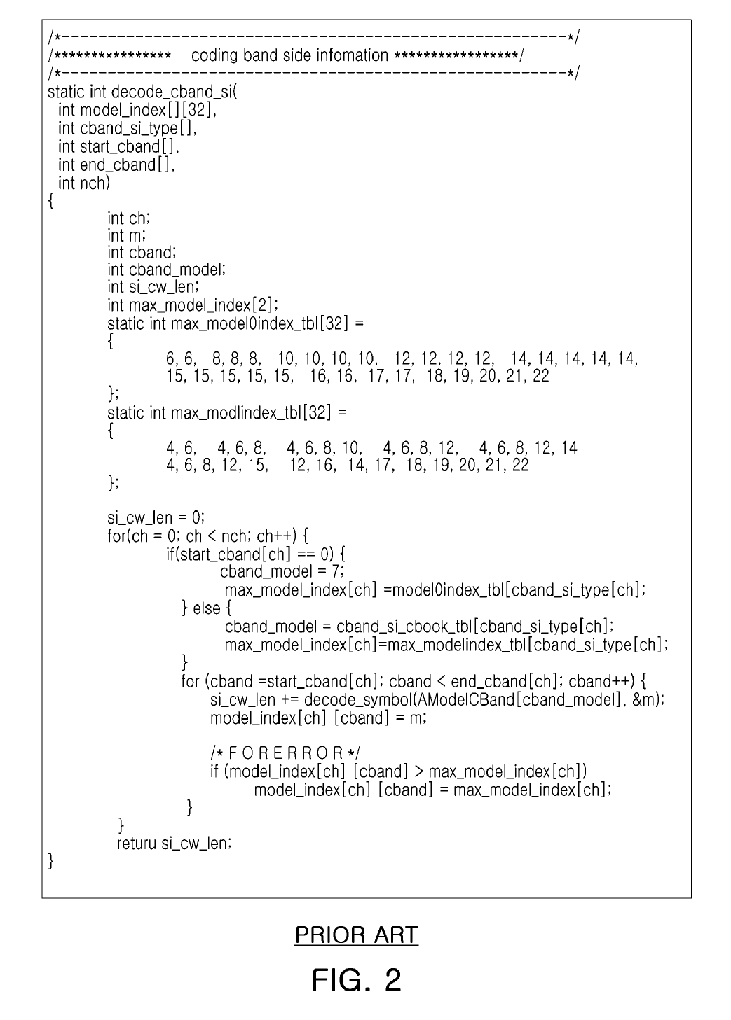

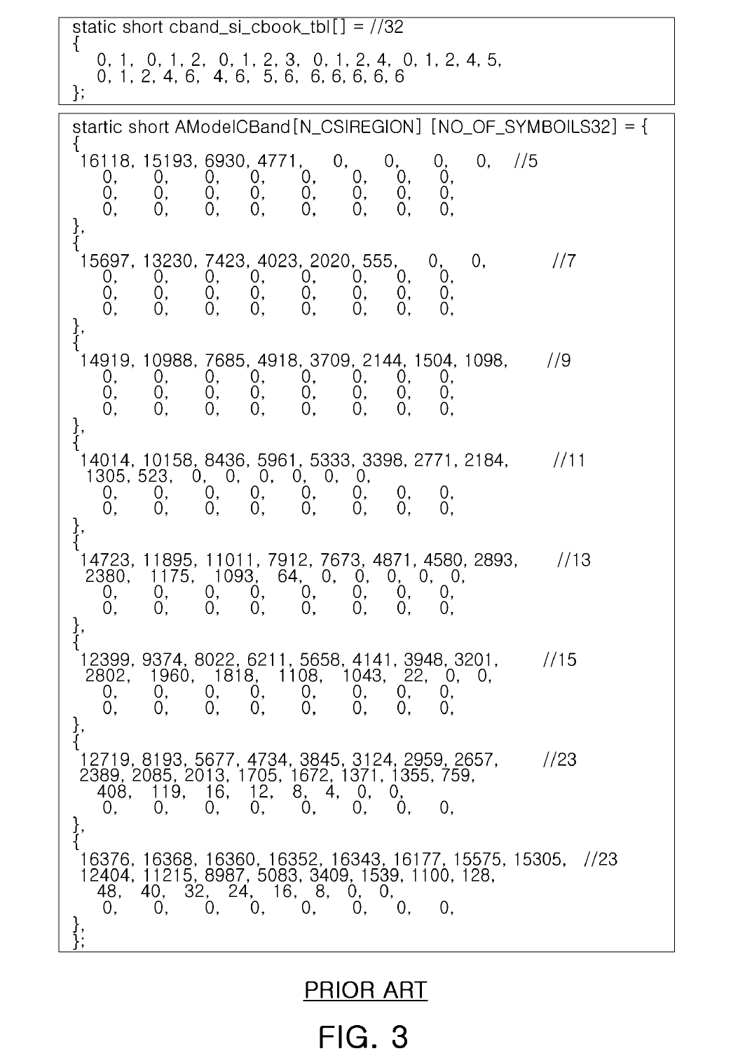

FIGS. 2 and 3 are views illustrating a method for extracting a probability model value from a probability model table according to the related art.

With reference to FIGS. 2 and 3, in the method for extracting a probability model value from a probability model table according to the related art, as shown in FIG. 2, a probability model index may be searched from a probability model table cband_si_cbook tbl[] as shown in FIG. 3 according to cband_si_type[ch] value transmitted from a transmission end, and then coding band supplementary information model_index[ch][cband] may be arithmetically decoded from a probability value table corresponding to a pertinent index from a probability value table AModelCBand[ ][ ].

Here, ch refers to each channel of stereo channels, and cband refers to a coding band (frequency band) to which an arithmetic coding is applied.

As shown in FIG. 3, it is noted that the probability value tables of the respective probability models have different lengths and include unnecessary probability values. Thus, the probability value tables illustrated in FIG. 3 may be separated by probability models and those which have been allocated with unnecessary probability values may be eliminated. This means that memory space unnecessarily used for storing probability value tables may be saved.

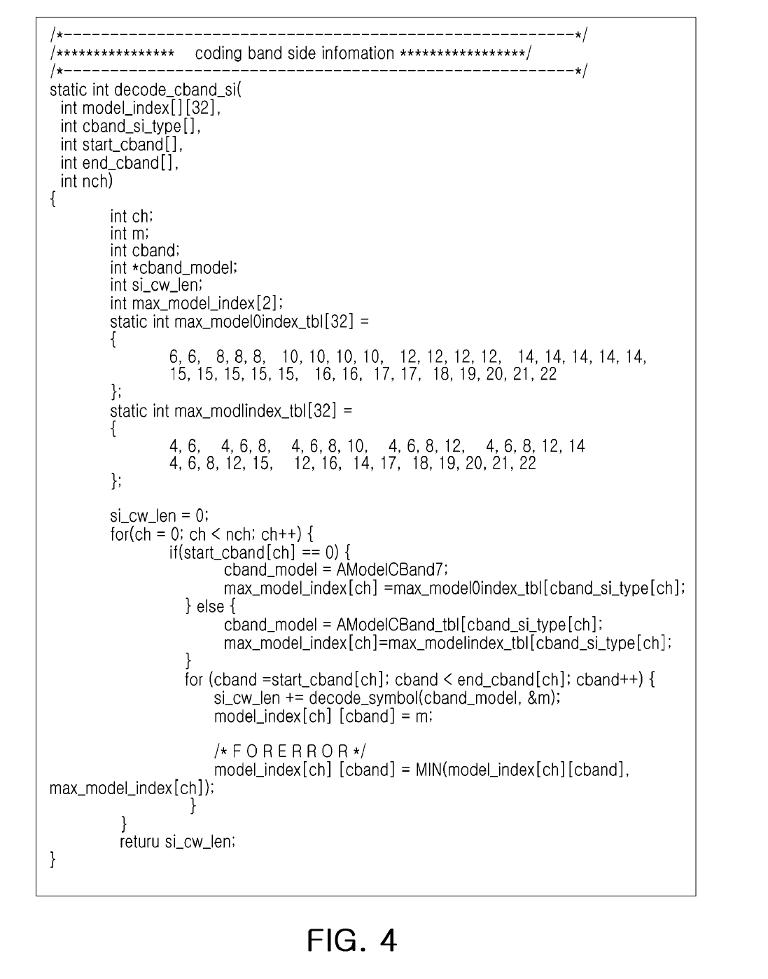

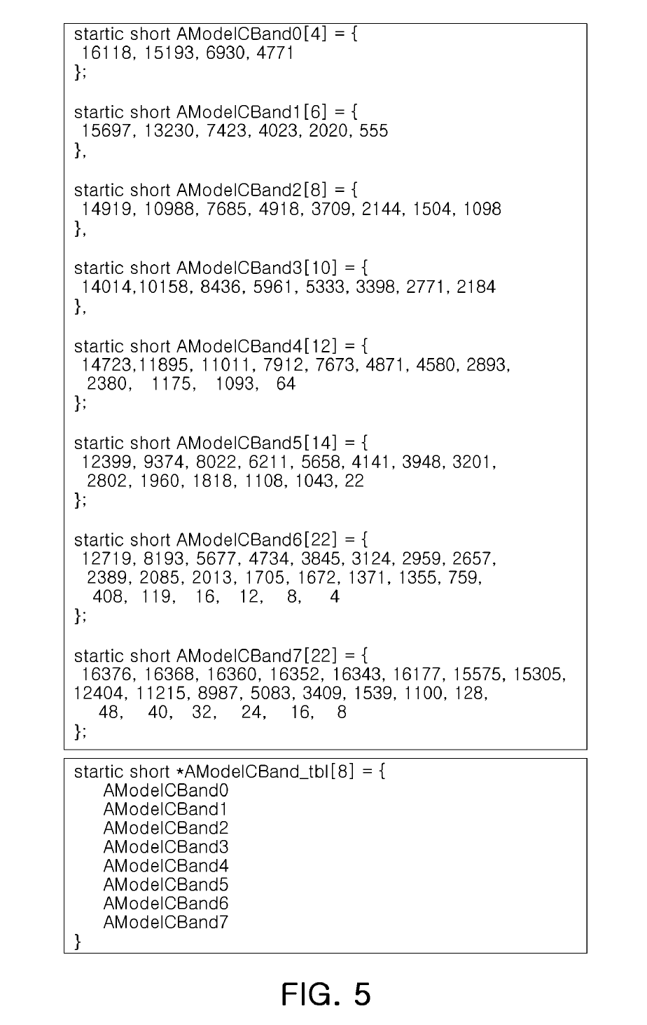

FIGS. 4 and 5 are views illustrating a method for extracting a probability model value from a probability model table according to an exemplary embodiment of the present invention.

With reference to FIGS. 4 and 5, in the method for extracting a probability model value from a probability model table according to an exemplary embodiment of the present invention. Specifically, FIG. 4 shows a pseudo-code for a process of arithmetically decoding coding band supplementary information proposed by the present invention, and FIG. 5 shows a segmented and reduced probability value table for arithmetically decoding coding band supplementary information.

As shown in FIG. 4, the coding band supplementary information model_index[ch][cband] can be arithmetically decoded by using the probability value table AModelCBand# in FIG. 5 according to the value cband_si_type[ch] with respect to a current channel transmitted from a transmission end.

As a result, the process of obtaining a probability model table in the arithmetic decoding process and obtaining the index of the probability model table, which accounts for 60% or more of the entire amount of calculation of the audio decoding apparatus, can be simplified.

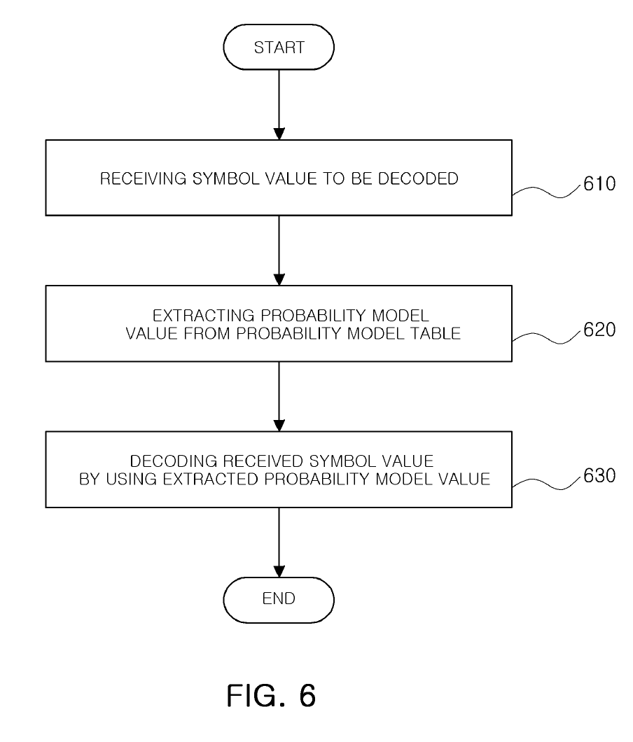

FIG. 6 is a flow chart illustrating the process of a method for decoding a symbol value by using a method for extracting a probability model value from a probability model table according to an exemplary embodiment of the present invention.

With reference to FIG. 6, a method for decoding a symbol value using a method for extracting a probability model value from a probability model table according to an exemplary embodiment of the present invention includes: a step (610) of receiving a symbol value to be decoded; a step (620) of extracting a probability model value from a probability model table; and a step (630) of decoding the received symbol value by using the extracted probability model value.

First, in the step (610) of receiving a symbol value to be decoded, a symbol value, to which a decoding method according to an exemplary embodiment of the present invention is to be applied, may be received.

Next, the step (620) of extracting the probability model value from the probability model table may include: segmenting and reducing the probability model table including a plurality of probability model values; disposing indexes on the basis of the segmented and reduced probability model table; and searching the probability model table for a probability model value by using the disposed indexes.

In addition, the disposing of the indexes on the basis of the segmented and reduced probability model table may be eliminating an unnecessary index searching process.

Thereafter, in the step (630) of decoding a symbol value, decoding may be performed by using the extracted probability model value. As a result, decoding is performed on the symbol value provided in step 610 by using the probability model value extracted in step 620.

Meanwhile, the symbol value decoding method may be used for BSAC (Bit Sliced Arithmetic Coding) decoding, an audio coding standard of terrestrial DMB (Digital Multimedia Broadcasting).

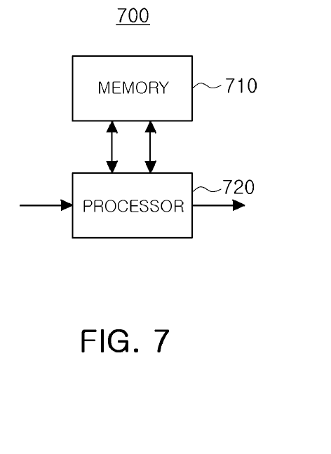

FIG. 7 is a schematic block diagram of an apparatus for decoding a symbol value by using a method for extracting a probability model value from a probability model table according to an exemplary embodiment of the present invention.

With reference to FIG. 7, the apparatus for decoding a symbol value by using a method for extracting a probability model value from a probability model table according to an exemplary embodiment of the present invention may include: a memory 710 storing a probability model table including a plurality of probability model values; and a processor 720 receiving a symbol value to be decoded, extracting a probability model value from the probability model table stored in the memory, and decoding the received symbol value.

Here, when the processor extracts the probability model value from the probability model table, it may segment and reduce the probability model table including a plurality of probability model values, dispose of indexes on the basis of the segmented and reduced probability model table, and search the probability model table for a probability model value.

In addition, the symbol value decoding apparatus may be used for BSAC (Bit Sliced Arithmetic Coding) decoding, an audio coding standard of terrestrial DMB (Digital Multimedia Broadcasting).

As set forth above, in the method for extracting a probability model value from a probability model table and the method and apparatus for decoding a symbol value using the same according to exemplary embodiments of the invention, the process of obtaining a probability model table of an arithmetic decoding process and obtaining an index of the probability model table, accounting for 60% or more of the entire amount of calculation of an audio decoding apparatus, can be simplified. In particular, because the process of obtaining the probability model table of the arithmetic decoding process and obtaining the index of the probability model table is simplified, a required amount of memory and calculation can be reduced, thus facilitating an implementation using a universal DSP, or the like.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for extracting a probability model value from a probability model table, the method comprising:
segmenting and reducing a probability model table including a plurality of probability model values;
disposing indexes on the basis of the segmented and reduced probability model table; and
searching the probability model table for a probability model value by using the disposed indexes.

2. The method of claim 1, wherein the disposing of the indexes on the basis of the segmented and reduced probability model table removes an unnecessary index searching process.

3. A method for decoding a symbol value using a method for extracting a probability model value from a probability model table, the method comprising:
receiving a symbol value to be decoded;
extracting a probability model value from a probability model table; and
decoding the received symbol value by using the extracted probability model value.

4. The method of claim 3, wherein the extracting of the probability model value from the probability model table comprises:
segmenting and reducing the probability model table including a plurality of probability model values;
disposing indexes on the basis of the segmented and reduced probability model table; and
searching the probability model table for a probability model value by using the disposed indexes.

5. The method of claim 4, wherein the disposing of the indexes on the basis of the segmented and reduced probability model table removes an unnecessary index searching process.

6. The method of claim 3, wherein the symbol value decoding method is used for BSAC (Bit Sliced Arithmetic Coding) decoding, an audio coding standard of terrestrial DMB (Digital Multimedia Broadcasting).

7. An apparatus for decoding a symbol value by using a method for extracting a probability model value from a probability model table, the apparatus comprising:
a memory storing a probability model table including a plurality of probability model values; and
a processor receiving a symbol value to be decoded, extracting a probability model value from the probability model table stored in the memory, and decoding the received symbol value.

8. The apparatus of claim 7, wherein when the processor extracts the probability model value from the probability model table, it segments and reduces the probability model table including a plurality of probability model values, disposes of indexes on the basis of the segmented and reduced probability model table, and searches the probability model table for a probability model value.

9. The apparatus of claim 7, wherein the symbol value decoding apparatus is used for BSAC (Bit Sliced Arithmetic Coding) decoding, an audio coding standard of terrestrial DMB (Digital Multimedia Broadcasting).
